(19) United States
(12) Patent Application Publication
(10) Pub. No.: US 2021/0046494 A1
(43) Pub. Date: Feb. 18, 2021

(54) ELECTRIC POWER SPRAYER WITH MULTI-VOLTAGE BATTERY SYSTEM AND METHOD THEREFOR

(71) Applicant: TECHTRONIC CORDLESS GP, Anderson, SC (US)

(72) Inventors: Chin Hung Lam, Hong Kong (CN); Zheng Jun Wang, Guangdong (CN)

(21) Appl. No.: 16/964,460

(22) PCT Filed: Feb. 2, 2018
(86) PCT No.: PCT/CN2018/075101

§ 371 Date: Jul. 23, 2020

(51) Int. Cl. B05B 9/08; H02M 3/02; H02J 7/00

(52) U.S. Cl. CPC B05B 9/0861; B05B 9/0888; H02J 2207/10; H02J 7/0044; H02M 3/02

(57) ABSTRACT

An electric power sprayer has a battery system with a battery interface and a voltage transformer. The battery interface may receive a plurality of different batteries having different voltages. The voltage transformer is operatively-connected to the battery interface and converts the different voltages into a standard voltage.

### FIELD OF THE INVENTION

The present invention relates to electric power sprayers. More specifically, the present invention relates to electric power sprayers having a battery. The present invention also relates to a method of using an electric power sprayer.

### BACKGROUND

Power sprayers are known in the art and can be powered by DC batteries, AC power and/or an internal combustion engine to turn a motor. Power sprayers are typically used to provide a pressurized liquid stream, typically a water stream, to clean surfaces such as walls, sidewalks, cars, etc. However, it is recognized that a power sprayer can also be used for other activities such as, for example, spraying pesticides, spraying herbicides, spraying fertilizer, spraying paint, fumigation, etc. However, power sprayers are distinguished from high pressure sprayers, in that the pressure is typically lower.

Typically in a power sprayer, a motor is operatively-connected to and turns a pump, typically a high pressure water pump. The water from a reservoir or a hose enters the pump through an inlet, and is passed through the fluid path of the pump creating a high pressure stream which exits from the pump through an outlet and flows through a hose to a wand for spraying.

The high pressure water stream is directed with the wand. Typically the wand has a handle which allows the user to easily and securely hold the wand, because as the water exits the wand with great velocity, it exerts a strong force pushing back on the wand.

Power sprayers are increasingly popular to clean materials such as concrete, wood, plastics, and metals. Typically power sprayers are sold with various attachments such as different wands for different spray patterns, hose extensions, etc. Electric power sprayers are increasingly popular but they have their drawbacks. Electric power sprayers connected to AC power have an unlimited run time, but the need for a cord limits their manoeuvrability. In contrast, a battery-powered electric power sprayer has unlimited manoeuvrability, but a limited runtime. Furthermore, while it is possible in such a sprayer to swap batteries as their power is used up, oftentimes there is only a limited number of a specific size/voltage battery available. Since batteries often require more time to charge than to discharge, there is always a potential timing lag problem. Also, while higher voltage batteries obviously last longer and possess more power, they tend to be significantly heavier which puts limits on and/or taxes the user's physical endurance.

However, as batteries may be cumbersome and heavy to carry around, it has been found that there is a need to be able to use multiple voltages of batteries with a power sprayer so as to increase its flexibility, power, spray distance, and/or battery discharge time.

Accordingly, there exists the need for an electric power sprayer which has improved mobility, power and/or and runtime. Furthermore, there is the need for an electric power sprayer which has improved flexibility regarding the batteries to be used. Furthermore, there is the need for an improved electric power sprayer which can be used by different users each having different levels of physical endurance. There also exists the need for a method for using multiple-voltage batteries on the same electric power sprayer.

### SUMMARY OF THE INVENTION

An electric power sprayer contains a battery system with a battery interface and a voltage transformer. The battery interface may receive a plurality of different batteries having different voltages. The voltage transformer is operatively-connected to the battery interface and converts the different voltages into a standard voltage.

A method for using an electric power sprayer having a battery system with a battery interface, a voltage transformer, and a first battery operatively-connected to the battery interface. The battery interface may receive a plurality of different batteries having different voltages. The voltage transformer is operatively-connected to the battery interface and converts the different voltages into a standard voltage. The first battery has a first voltage.

The method further contains the steps of spraying a liquid with the electric power sprayer, disconnecting the first battery from the battery interface, providing a second battery comprising a second voltage, operatively-connecting a second battery to the battery interface, and spraying a liquid with the electric power sprayer, where the first voltage is different from the second voltage.

Without intending to be limited by theory it is believed that the present invention provides an improved electric power sprayer which has increased flexibility, mobility, power, and/or runtime as compared to other power sprayers. For example, when the user has finished using a battery, they may switch to another battery and continue spraying without damaging the power sprayer, even if the voltage would otherwise be incompatible. In addition, it is recognized that higher voltage batteries typically provide more power, a longer runtime, etc. however, these batteries are also typically heavier, sometimes significantly heavier. Therefore, the present invention allows the user, if desired, to switch from a regular heavier battery to different lighter batteries so as to more easily use the electric sprayer without injuring themselves or overly tasking themselves physically. This may allow two users with different levels of physical endurance to use the same sprayer, without having to purchase two separate sprayers.

### BRIEF DESCRIPTION OF THE DRAWINGS

FIG. 1 shows a partially cut-away perspective view of an embodiment of the electric power sprayer of the present invention;

FIG. 2 shows a side-view of the embodiment of FIG. 1 . . . ;

FIG. 3 shows a schematic diagram of an embodiment of electric connections useful herein; and

FIG. 3 shows a partial top perspective view of an embodiment of the housing of the present invention.

The figures herein are for illustrative purposes only and are not necessarily drawn to scale.

### DESCRIPTION OF THE PREFERRED EMBODIMENTS

Unless otherwise specifically provided, all tests herein are conducted at standard conditions which include a room and testing temperature of 25° C., sea level (1 atm.) pressure, pH 7 and all measurements are made in metric units, unless otherwise specifically noted. Furthermore, all percentages, ratios, etc. herein are by weight, unless specifically indicated otherwise.

An electric power sprayer contains a battery system having a battery interface and a voltage transformer. The battery interface may receive a plurality of different batteries having different voltages. The voltage transformer converts different voltages into a standard voltage.

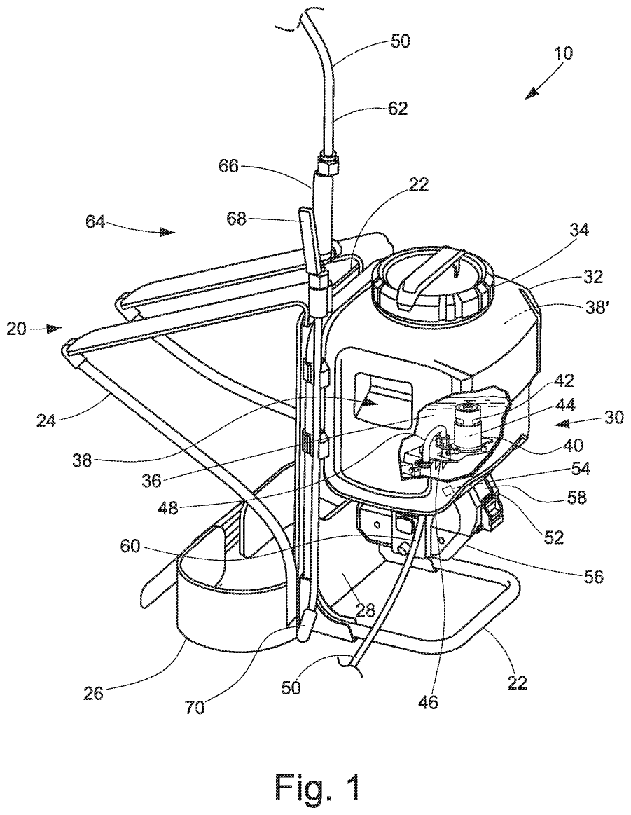

Turning to the Figures, FIG. 1 shows a partially cut-away perspective view of an embodiment of the electric power sprayer, 10, of the present invention. The electric power sprayer, 10, has a backpack support, 20, which contains a frame, 22, and shoulder straps, 24, and a belt, 26. The shoulder straps, 24, are connected to the frame, 22, so as to suspend the frame, 22, on the user's shoulders. The belt, 26, is also connected to the frame, 22, and is present in order to hold the frame, 22, snugly against the user's back.

The belt and/or the shoulder straps may also contain padding (see below), and may be further made from materials known in the art, such as, for example, a plastic and a combination thereof; or nylon, polypropylene, polyethylene, kevlar, and a combination thereof. The belt and/or the shoulder strap may be woven from the above materials, and/or formed by, for example, extrusion and other methods known in the art.

The electric power sprayer, 10, is either removably-attached or permanently-attached to the frame, 22. The frame, 22, is composed of a strong, lightweight material, typically a plastic, a metal, a fibre, and a combination thereof; or a plastic, a metal, and a combination thereof; or a metal and a combination thereof; or a polymer, aluminium, steel, and a combination thereof.

Also attached to the frame, 22, is padding, 28, which helps to make the frame, 22, more comfortable. In addition, the padding, 28, may also help to absorb sound and/or vibrations from the electric power sprayer, 10, during use. As a user may wish to use a power sprayer for a long time, or continuously for a long time, or even all day long, it is believed that the padding helps to make the power sprayer more comfortable for the user to wear on the back, to use, and also to reduce fatigue and the chance of injury. Accordingly, the padding useful herein may include, for example, a foam, a fabric, a plastic, and a combination thereof; or a foam rubber, cotton, nylon, polypropylene, polyethylene, and a combination thereof; or a foam rubber, a plastic, nylon, a fabric, and a combination thereof; or a foam rubber, nylon, polypropylene, and a combination thereof. In an embodiment herein, the padding, the strap and/or the belt are removable, or removable from the frame, for washing, etc. in case they become dirty or worn out and need to be replaced.

In the embodiment of FIG. 1, the electric power sprayer, 10, has a housing, 30. The housing contains the liquid reservoir, 32, which is in this embodiment is shown as a tank, for containing the material; or the liquid; or a pesticide, a herbicide, a fertilizer, paint, a fumigant, a surfactant, an abrasive, water and a combination thereof to be sprayed. The housing, 30, contains a cap, 34, which in this case is removable cap that screws on to the liquid reservoir, 32, to seal the liquid reservoir, 32, and to prevent liquid, 36, inside the liquid reservoir, 32, from spilling. In an embodiment herein, the tank may contain, for example, from about 1 litre to about 50 litres; or from about 2 litres to about 45 litres; or from about 3 litres to about 37 litres; or from about 4 litres to about 25 litres.

The housing, 30, also contains an optional handle, 38, formed into the liquid reservoir, 32. Although not shown, another handle, 38′, is present on the opposite side of the liquid reservoir, 32, from the handle, 38. In an embodiment herein the handle is integral to the housing, the tank or a combination thereof. The housing, 30, also contains a pump, 40, inside of the liquid reservoir, 30, for pumping the liquid, 36. The liquid reservoir may be covered by an optional plastic layer as well to, for example, absorb impacts, protect the liquid reservoir, prevent UV damage, etc. The pump, 40, contains an inlet, 42, where liquid may enter the inlet, a fluid path, 44, running through the pump, 40. Thus, the liquid reservoir, 32; or the tank, is fluidly-connected to the inlet, 42. The pump, 40, also contains an outlet, 46, which connects to a tube, 48, which leads out of the liquid reservoir, 32, to the outside of the housing, 30, where it connects to the hose, 50. The tube is typically a hard, resilient material, such as, for example, a metal, a plastic, a resin, and a combination thereof; or steel, iron, polyvinyl chloride (PVC), and a combination thereof. This is because during use, the high pressure liquid may rupture a less resilient material, and/or may undesirably deform a soft material. In an embodiment of the present invention, the pressure in the sprayer is not so high, and therefore does not require the high tolerances needed in, for example, a high pressure washer.

The housing, 30, also contains a battery interface, 52, which is operatively-connected to a control circuit, 54. The control circuit, 54, is operatively connected to the pump, 40, to control the output of the pump, 40. In an embodiment herein, the control circuit, 54, is operatively-connected to the pump, 40, and provides an adjustable flow rate, an adjustable pressure, and/or a combination thereof. The control circuit, 54, is also operatively-connected to the battery interface, 52, as well.

In the embodiment of FIG. 1, a battery, 56, is connected to the battery interface, 52. The battery, 56, in FIG. 1 is a 18 v battery; however, the battery interface, is sized and designed so that it may receive; or receive and hold, a plurality of different batteries having different voltages. In an embodiment herein, the batteries; or the plurality of batteries, have a voltage of from about 9 v to about 120 v; or from about 10 v to about 75 v; or from about 11 v to about 60 v.

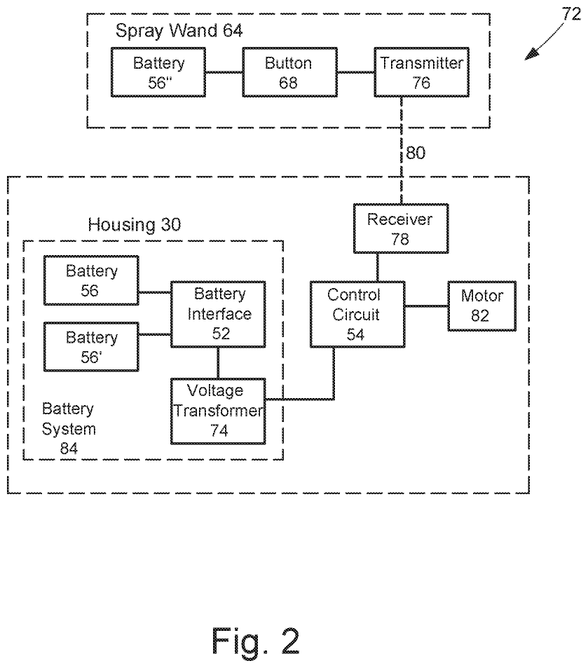

The battery useful herein is typically an electric battery; or a rechargeable electric battery; or a rechargeable smart battery. In an embodiment herein, the power washer contains a plurality of smart batteries. When present, the smart batteries and the control circuit (see FIG. 2 at 54) are able to interact and communicate such that the smart batteries discharge at the optimum voltage and/or current.

The battery useful herein typically possesses a mAh rating of greater than 750 mAh; or from about 750 mAh to about 15000 mAh; or from about 1000 mAh to about 12500 mAh; or from about 1100 mAh to about 10000 mAh. The chemistry in the battery is largely irrelevant, but may be, for example nickel-cadmium, lithium ion, nickel metal hydride, lead acid, nickel hydrogen, and a combination thereof; or lithium ion. Generally, higher energy-density batteries are preferred.

The battery herein may be a smart battery, which indicates that the battery (or the battery cell(s), or the casing, etc.) contain a physical, electrical, or other method/structure to control the discharge and/or charging of the battery. The person skilled in the art understands that this may be accomplished by, for example, including battery controller, a variety of different electrical terminals to connect to the control circuit, a software to control the battery, etc. Such a smart battery may control one or more features of the battery, for example, voltage, current, temperature, charging, discharging, etc.

In an embodiment herein, the smart battery contains a plurality of terminals for electrically-connecting to the power washer's electrical system. The terminals may include, for example, a high-current discharge terminal, a low-current discharge terminal, a battery pack identification terminal, a battery pack temperature terminal, and/or a positive voltage terminal. In some embodiments, the battery pack housing does not include circuitry for controlling the switching between the low-current discharge terminal and the high-current discharge terminal, and in other embodiments, the battery pack does contain such circuitry. See, for example, the smart battery described in Chinese Patent Publication CN 102301246 A to Techtronic Industries, published on Dec. 28, 2001. Such a smart battery may be especially useful when the power washer contains a boost function.

A battery eject button, 58, is located on the housing to disconnect the battery, 56, from the battery interface, 52. Without intending to be limited by theory, it is believed that this button is useful for ejecting the battery especially when the user's hands may be wet, thus reducing the chance of a short circuit. In an embodiment herein, the battery ejection button is separately sealed and located away from the battery interface so as to reduce the chance of a short circuit. In an embodiment herein, as a safety feature, when the battery eject button is pushed, then the electric circuit is broken, and/or the electric power sprayer is turned off, so that there is a reduced chance of activating the motor and/or pump.

As noted herein, the tube, 48, leads to the outside of the housing, 30, where the tube, 48, connects to a hose, 50. The hose, 50, contains a first end, 60, and a second end, 62, opposite the first end, 60. The first end, 60, which is fluidly-connected to the outlet, 48. In an embodiment herein, the hose is typically a high pressure hose made specifically to withstand and safely contain the high pressure liquid running therethrough during use of the power sprayer. In an embodiment herein, the high pressure hose is capable of withstanding a pressure of greater than about 50 psi (0.34 MPa); or of from about 50 psi (0.34 MPa) to about 5000 psi (34 MPa); or from about 100 psi (0.68 MPa) to about 4000 psi (27.6 MPa); or from about 125 psi (0.86 MPa) to about 3500 psi (24.1 MPa). However, in an embodiment herein, a high pressure hose is not needed and therefore a regular hose may suffice.

The second end, 62, of the hose, 50, is fluidly-connected to a spray wand, 64, which contains a handle, 66. The handle, 66, contains a button, 68, which is in this case similar to a trigger. The spray wand, 64, also contains a spray tip, 70, from which the high pressure spray exits the spray wand, 64. The spray tip may be adjustable to provide a variety of liquid spray patterns such as a stream, a fan, and a combination thereof.

The button, 68, is typically compressed or depressed to start the flow of the high pressure spray. In an embodiment herein, the flow rate of the liquid is an adjustable flow rate and the adjustable flow rate is dependent on the amount of pressure exerted on the button during use. For example, the greater the pressure exerted upon the button, the greater the flow rate of the liquid being sprayed. In an embodiment herein, the pressure; or spray pressure, of the liquid is an adjustable pressure and the adjustable pressure is dependent on the amount of pressure exerted on the button during use. For example, the greater the pressure exerted upon the button, the greater the pressure of the liquid being sprayed. In an embodiment herein, both the flow rate and the pressure of the liquid is adjustable and is dependent on the amount of pressure exerted on the button during use. For example, the greater the pressure exerted upon the button, the greater the flow rate and the pressure of the liquid being sprayed.

FIG. 2 shows a schematic diagram of an embodiment of electric connections, 72, useful herein. The electric connections, 72, show a plurality of batteries, 56 and 56′, operatively-connected; or attached, to a battery interface, 52, at the same time. In another embodiment, only a single battery may attach to the battery interface at a time; however, in such a case, the battery interface is able to accommodate and attach to other different voltage batteries at separate times. For example, the user may attach a 18 v battery to the battery interface until it is used up. Then the user may replace the 18 v battery in the battery interface for a 36 v or a 58 v battery to continue working. Without intending to be limited by theory, it is believed that such a function helps to provide needed flexibility to the users, allowing them to use any voltage battery which is convenient and available at the time.

Typically each battery has its own voltage, and in many cases, the voltages of each battery will be different. Therefore the plurality of different batteries may correspond to different voltages; or a plurality of different voltages. The battery interface, 52, is operatively-connected to; or passes electricity to, the voltage transformer, 74, which then converts the different voltages to a standard voltage which is typically of from about 10 v to about 30 v; or from about 12 v to about 25 v. In an embodiment herein, the voltage transformer converts the different voltages to a standard voltage of from about 20 v to about 45 v; or from about 25 v to about 42 v; or from about 30 v to about 40 v. In an embodiment herein, the voltage transformer converts the different voltages to a standard voltage of from about 40 v to about 75 v; or from about 45 v to about 70 v; or from about 55 v to about 60 v. The standard voltage herein is the normal voltage, for example, about 20 v, that the rest of the electric circuit is designed to work at, and/or the optimum voltage for the electric circuit.

In an embodiment herein, the voltage transformer is a DC-DC voltage transformer; or a DC-DC step-down converter (a.k.a., a “DC-DC step-down transformer”), a DC-DC step-up converter (a.k.a., a DC-DC step-up transformer”), DC-DC step-down circuitry, DC-DC step up circuitry, and a combination thereof, depending on the expected types of batteries and the motor/pump/control circuit configurations. In an embodiment herein, the voltage transformer automatically converts the different voltages into the standard voltage. In another embodiment herein, the voltage transformer has a physical or electronic switch which needs to be set in order to convert the different voltages into the standard voltage. The voltage transformer, 74, passes electricity (at the standard voltage) to the control circuit, 54.

In an embodiment herein, when a battery is inserted into, electrically-connected to, and/or otherwise operatively-attached to the battery interface, the battery interface and/or the control circuit, 54, automatically senses the battery's voltage and adjusts the voltage accordingly, either directly or indirectly. In an embodiment herein, the voltage transformer is a pulse width modulation rectifier. In an embodiment herein, the voltage transformer achieves the desired voltage via designated circuitry. In an embodiment herein, the designated circuitry may be in, for example, the control circuit, and/or in the battery interface. In an embodiment herein, when a plurality of batteries are connected to the battery interface, each battery has a separate circuit system between the battery and the voltage transformer.

In FIG. 2, the electric circuit also shows that the button, 68, is operatively-connected to a transmitter, 76, while the control circuit, 54, is also connected to a receiver, 78. The transmitter, 76, is a wireless transmitter, and the receiver is a paired to and compatible with the wireless transmitter such that a signal, 80, transmitted from the transmitter is receivable; or received by the receiver. Accordingly, the control circuit, 54, is operatively-connected to the button, 68, and visa-versa.

In an embodiment herein the transmitter and/or the receiver is a transceiver. In an embodiment herein, the transmitter and/or the receiver is a transceiver microchip and the signal may be encrypted or non-encrypted. In an embodiment herein the transmitter and the receiver each contain an encryption key, and the signal is encrypted with the encryption key.

The signal useful herein may be a radio signal, a light signal, a sonic signal, an electric signal, a magnetic signal, and a combination thereof; or a radio signal, a light signal and a combination thereof; or a radio signal; or a light signal. A radio signal useful herein may be a Bluetooth™ signal, a Wi-Fi signal, a Z-Wave™ signal, a ZigBee™ signal, and a combination thereof; or a Bluetooth™ signal; or a Wi-Fi signal.

As the button, 68, and the transmitter, 76, may either or both require electricity to work, a battery, 56″, is provided which may be, for example, in the spray wand (see FIG. 1 at 64). The battery, 56″, useful in the spray wand (see FIG. 1 at 64) is typically a low-voltage standard battery such as a disposable battery; or a 1.5 v AAA battery, a 1.5 v AA battery, a 1.5 v C battery, a 1.5 v D battery, a 9-volt battery, a watch battery, etc.

In another embodiment, the button may be physically connected to the control circuit via, for example, wires.

In the embodiment of FIG. 2, the control circuit, 54, is connected to the motor, 82, which is typically an electric motor, which then activates the pump (see FIG. 1 at 40). In an embodiment herein, the control circuit is operatively-connected to the pump via the motor. In an embodiment herein, the adjustable flow rate, the adjustable pressure, and/or the combination thereof is controlled by the control circuit by adjusting the speed of the motor, such as by adjusting the wattage sent to the motor.

In an embodiment herein, the motor is a brushless motor, such as known in the art. See for example, WO 2015/165012 to Foster Assets Corporation, published on 5 Nov. 2015. In the typical embodiment herein, the brushless motor contains a switching element to selectively enable and disable the driving mechanism for the motor. The brushless motor may further contain a printed circuit board or other type of controller therein, as seen in WO 2014/031539 A1 to Milwaukee Electric Tool Corp., published on Feb. 27, 2014. In an embodiment herein, the power washer herein contains a motor controller, which may be contained within or connected to the control circuit, 40, the motor, 82, or may be located elsewhere.

A battery system, 84, contains specifically the batteries, 56 and 56′, the battery interface, 52, and the voltage transformer, 74. Typically, as is shown in FIG. 2, the spray wand, 64, will contain, among other parts, the battery, 56″, the button, 68, and the transmitter, 76. The housing, 30, will in turn contain, among other parts, the battery system, 84 (i.e., the batteries, 56 and 56′, the battery interface, 52, the voltage transformer, 74), the control circuit, 54, the receiver, 78, and the pump, 40.

It is understood that the control circuit may control the pump (see FIG. 1 at 40) either directly or indirectly as desired. In an embodiment herein, the control circuit controls the pump speed directly. In an embodiment herein, the control circuit controls the pump speed indirectly via, for example, by controlling the battery output and/or motor speed.

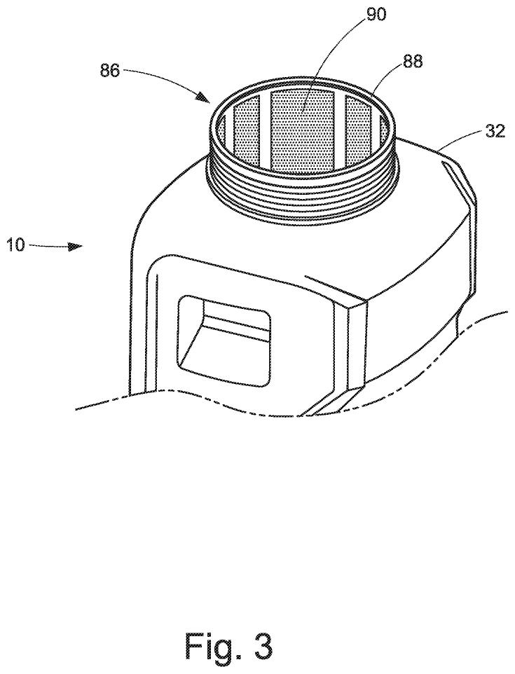

FIG. 3 shows a partial top perspective view of an embodiment of the housing, 30, of the present invention. In this embodiment, a liquid reservoir, 32, is shown where the cap (see FIG. 1 at 34), is removed. A reservoir mouth, 86, can be seen, which contains an insert, 88, which fits neatly into the reservoir mouth, 86. The insert, 88, contains a filter, 90, therein to prevent debris from entering the liquid reservoir, 32, and thereby preventing fouling of the pump (see FIG. 1 at 40), tube (see FIG. 1 a 48), hose (see FIG. 1 at 50), etc. This in turn reduces maintenance and damage to the electric power sprayer, 10.

The filter useful herein typically consists of a mesh, a screen, etc. and may be flat or shaped as desired. As different electric power sprayers are used for different purposes and contain different liquids, it is understood that the fineness of the mesh should be calculated to avoid the most common debris which causes fouling for the electric power sprayer. However, in an embodiment herein, the filter is a mesh, wherein the mesh has holes having a diameter (in the case of approximately round holes) of from about 0.01 mm to about 10 mm; or from about 0.1 mm to about 5 mm; or from about 0.75 mm to about 2.5 mm. In an embodiment where the mesh has square, rectangular, parallelogram, etc. shaped holes, then the holes have a longest length (or width, as the case may be) of from about 0.01 mm to about 10 mm; or from about 0.1 mm to about 5 mm; or from about 0.75 mm to about 2.5 mm, or the equivalent thereof. The filter herein may be permanent or disposable as desired. The filter herein may be formed of, for example, a plastic, a fabric, a metal, a ceramic, and a mixture thereof; or a plastic, a metal, and a mixture thereof; or a plastic.

### Method of Use:

In an embodiment of the invention, the electric power sprayer (See, e.g., FIG. 1 at 10) herein is provided, and a first battery (see FIG. 2 at 56) is operatively-connected to the battery interface. The first battery has a first voltage. A second battery (see, e.g., FIG. 2 at 56′) is provided having a second voltage. In an embodiment herein, the first voltage and the second voltage are different by at least about 4 v; or at least about 8 v; or at least about 12 v; or from about 4 v to about 120 v; or from about 8 v to about 100 v; or from about 12 v to about 50 v.

The electric power sprayer is used to spray a liquid such as in a liquid stream. Then the electric power sprayer may be turned off, and/or the button released so that the motor and/or the pump has stopped. If present, the battery eject button is pushed to safely disconnect; or eject, the first battery from the battery interface.

The second battery is then operatively-connected; or inserted, into the battery interface so as to power the electric power sprayer. Thus, even though the first voltage and the second voltage are different; or the first voltage and the second voltage are different by at least about 4 v; or at least about 8 v; or at least about 12 v; or from about 4 v to about 120 v; or from about 8 v to about 100 v; or from about 12 v to about 50 v, the electric power sprayer remains undamaged due to the voltage transformer.

It is understood that in a normal electric power sprayer without a voltage transformer, if the standard voltage is very high, and the battery has a low voltage, then the electric power sprayer simply will not work. In contrast, in a normal electric power sprayer without a voltage transformer, if the standard voltage is very low, and the battery voltage is too high, it could cause damage to and/or short circuiting of, the electric power sprayer. However, it has been recognized that this problem can be solved by providing a voltage transformer which then converts a voltage that would otherwise be a damaging voltage and/or inoperable voltage into a usable standard voltage. Accordingly, in an embodiment herein, the use of the a battery and a second battery each having a different voltage, does not cause any damage to the electric power sprayer when each is separately operatively-connected to the battery interface. In an embodiment herein, the use of a first battery and the second battery each having a different voltage, does not cause any damage to the electric power sprayer when each of them is operatively-connected to the battery interface at the same time. In an embodiment herein, the use of a first battery and the second battery each having a different voltage, does not cause any damage to the electric power sprayer when each of them is operatively-connected to the battery interface sequentially.

Accordingly, the present invention may provide significant advantages to the user as described herein.

It should be understood that the above only illustrates and describes examples whereby the present invention may be carried out, and that modifications and/or alterations may be made thereto without departing from the spirit of the invention.

It should also be understood that certain features of the invention, which are, for clarity, described in the context of separate embodiments, may also be provided in combination in a single embodiment. Conversely, various features of the invention which are, for brevity, described in the context of a single embodiment, may also be provided separately, or in any suitable subcombination.

1. An electric power sprayer comprising a battery system comprising:
a battery interface, wherein the battery interface may receive a plurality of different batteries having different voltages, and
a voltage transformer operatively-connected to the battery interface, to convert the different voltages into a standard voltage.

2. The electric power sprayer according to claim 1, further comprising a backpack support.

3. The electric power sprayer according to claim 1, wherein the standard voltage is from about 10 v to about 30 v; or from about 12 v to about 25 v.

4. The electric power sprayer according to claim 1, wherein the plurality of different batteries each comprise a voltage of from about 9 v to about 120 v; or from about 10 v to about 75 v; or from about 11 v to about 60 v.

5. The electric power sprayer according to claim 1, wherein the backpack support further comprises a shoulder strap.

6. The electric power sprayer according to claim 1, wherein the voltage transformer is a DC-DC step-down converter, a DC-DC step up converter, DC-DC step-down circuitry, DC-DC step up circuitry, or a combination thereof.

7. The electric power sprayer according to claim 1, wherein the electric power sprayer comprises an adjustable flow rate, an adjustable pressure, or a combination thereof.

8. The electric power sprayer according to claim 1, wherein the electric power sprayer is for spraying a liquid, the electric power sprayer further comprising:
a housing comprising:
a pump comprising:
an inlet wherein the liquid enters the inlet;
a fluid path through the pump, wherein the liquid flows through the fluid path; and
an outlet, wherein the liquid exits the outlet, wherein the pump is operatively-connected to the battery interface; and
a liquid reservoir, wherein the liquid reservoir is fluidly-connected to the inlet;
a hose comprising a first end and a second end opposite the first end, wherein the first end is fluidly-connected to the outlet;
a handle fluidly-connected to the second end, wherein the handle comprises a button; and
a control circuit operatively-connected to the pump, wherein the control circuit is operatively-connected to the battery interface, wherein the control circuit is operatively-connected to the button, wherein the control circuit controls the output of the pump, and wherein the control circuit provides an adjustable flow rate, an adjustable pressure, or a combination thereof.

9. The electric power sprayer according to claim 8, wherein the adjustable flow rate, the adjustable pressure, or the combination thereof is dependent upon the pressure exerted on the button during use.

10. The electric power sprayer according to claim 8, further comprising a transmitter operatively-connected to the button and a receiver operatively-connected to the control circuit and wherein the transmitter transmits a signal the receiver.

11. The electric power sprayer according to claim 10, wherein the transmitter is a wireless transmitter and wherein the receiver is a wireless receiver.

12. The electric power sprayer according to claim 11, wherein the transmitter and the receiver comprise an encryption key and wherein the signal is encrypted with the encryption key.

13. The electric power sprayer according claim 1, wherein the voltage transformer automatically converts the different voltages into the standard voltage.

14. The electric power sprayer according to claim 1, wherein the battery interface may comprise a plurality of batteries operatively-connected to the battery interface at the same time.

15. A method for using an electric power sprayer, wherein the electric power sprayer comprises a battery system comprising:
a battery interface wherein the battery interface may receive a plurality of different batteries having different voltages;
a voltage transformer to convert the different voltages into a standard voltage; and
a first battery operatively-connected to the battery interface wherein the first battery comprises a first voltage,
wherein the method comprises the steps of:
spraying a liquid with the electric power sprayer;
disconnecting the first battery from the battery interface;
providing a second battery comprising a second voltage;
operatively-connecting a second battery to the battery interface; and
spraying a liquid with the electric power sprayer,
wherein the first voltage and the second voltage are different.

16. The method according to claim 15, wherein the first voltage and the second voltage are different by at least about 4 v; or at least about 8 v; or at least about 12 v.

17. The method according to claim 15, wherein the spraying of liquid with the second battery operatively-connected to the battery interface does not cause any damage to the electric power sprayer.
